(19) United States
(12) Patent Application Publication
(10) Pub. No.: US 2005/0117864 A1
(43) Pub. Date: Jun. 2, 2005

(54) Method of synthesis and delivery of complex pharmaceuticals, chemical substances and polymers through the process of electrospraying, electrospinning or extrusion utilizing holey fibers

(76) Inventors: Michael E. Dziekan, Naugatuck, CT (US); Joseph J. Bango, New Haven, CT (US); John B. Fenn, Richmond, VA (US)

Correspondence Address: JOSEPH J. BANGO;CONNECTICUT ANALYTICAL CORPORATION, 696 AMITY ROAD, BETHANY, CT, 06524, US

(21) Appl. No.: 11/000,723

(22) Filed: Dec. 1, 2004

Related U.S. Application Data
(60) Provisional application No. 60/525,948, filed on Dec. 1, 2003.

(51) Int. Cl. G02B 6/20

(52) U.S. Cl. 385/125

(57) ABSTRACT

A method of synthesizing complex, multi-part pharmaceuticals, chemical substances and engineered polymers through the process of electrospraying, electrospinning or extrusion utilizing tiny glass fiber known as “Holey” Fibers. The “holey” fibers have a unique property associated with them as they contain various combinations of micron sized holes running the length of the glass fiber. The holes can be made homogenous, i.e. all the same diameter, or of varying dimensions in concentric rings, enabling several chemicals to be combined together at synthesis. The advantage of using a glass holey fiber is that it is made from a chemically inert glass, that will not affect to chemicals involved with the exception of certain fluorine substances.

### CROSS REFERENCE TO RELATED APPLICATIONS

Provisional Application No. 60/525,948 was filed on 1 Dec. 2003

### BACKGROUND

1. Field of Invention

This invention details a method of synthesizing complex, multi-part pharmaceuticals, chemical substances and engineered polymers through the process of electrospraying or extrusion utilizing tiny glass fiber known as “Holey” Fibers. The “holey” fibers have a unique property associated with them as they contain various combinations of micron sized holes running the length of the glass fiber. The holes can be made homogenous, i.e. all the same diameter, or of varying dimensions in concentric rings, enabling several chemicals to be combined together at synthesis. The advantage of using a glass holey fiber is that it is made from a chemically inert glass, that will not affect to chemicals involved—with the exception of certain fluorine substances.

2. Background Description of Prior Art

As materials and pharmaceuticals get more and more advanced, the requirement of precise control to a minute amount becomes more and more paramount. This can be attested to by anyone who has tried to electrospin microfibers. These fibers can have a diameter from micrometers (10⁻⁶ m) down to nanometers (10⁻⁹ m). It is all but impossible to construct a material from nano-fibers through mechanical means with current technology. The use of electrospinning has brought to fruition the ability of man to mimic what Nature does on a daily basis. One of the biggest “Nature” engineered materials that have frustrated the efforts of man to recreate is Spider silk. Through the use of several small spinnerets, a Spider can mix several distinct chemicals in varying amounts that combine in the air, or “on route” to its destination to form a fine, super-strong single fiber. The spinneret's are usually arranged in a coaxial fashion enabling an “inner” chemical to be coated with an “outer” chemical to produce a single strand of silk that is stronger and much more flexible than steel (pound per pound). One of the biggest problems when dealing with producing engineered nano-fibers is controlling the amount of fluid needed to construct the nano-fiber. Typically it is through the use of a costly and rather large mechanical syringe pump. It was through the insight of a Dr. John B. Fenn, who was the recipient of the Nobel Prize in chemistry in December 2002 who suggested that a self-regulating, completely passive means already exists—a wick. Anyone who has ever burned candles has noticed that the flame steadily burns by being fed the appropriate amount of melted wax, at the appropriate rate. Not too much, not too little, as Goldylocks stated while she was in the house of the three bears, it is “just right”. It was later proposed that a suitable “wick” material could be made from that of a “Holey” optical Fiber. It turns out that while using a “Holey” fiber as a feed source, and through capillary action, the liquid pulled off the jet of the “so called” Taylor cone, will exactly balance that being replenished. For the purposes of electrospraying, this means several things; that the costly and large mechanical hydrostatic feed pump is no longer needed, and the problem of trying to get a “wicking” material inside a small diameter orifice or needle is no longer an issue. The tiny holes running the length of the “Holey” fiber act as individual capillaries. The production of these “Holey” fibers allow for the arrangement of concentric rings of differently spaced holes that would enable a co-axial fluid flow, somewhat akin to that of a Spider grouping of spinnerets. The holey fiber could be utilized by itself, with a concentric set of holes to enable different chemical solutions to be used without any mixing until they exit the fiber, or as a plurality of holey fibers enclosed in a rigid shell that will enable each individual fiber to carry a different chemical solution. The various chemical solutions are combined only as they exit each holey fiber. It would be possible to have an arrangement of three or more holey fibers, with each holey fiber attached to a distinct reservoir of chemical solution, giving three or more separate electrosprays, extruded or electrospun sources that will combine as they exit each holey fiber. If seven different holey fibers are used in the same fashion, then seven distinct chemical solutions could be utilized. If each holey fiber were of the co-axial arrangement, then a total of fourteen different chemical solutions could be utilized. The number of distinct chemical solutions available for electrospraying, extruding or electrospinning would only depend on the number of holey fibers held in the rigid structure.

### BRIEF DESCRIPTION OF THE DRAWINGS

FIG. 1 shows a Scanning Electron Microscope (SEM) picture or micrograph of the front face of a section of holey optical fiber. The micrograph shows the arrangement of the holes running through the length of the glass fiber.

FIG. 2 shows a Scanning Electron Microscope (SEM) picture or micrograph of a close up of the front face of a section of holey optical fiber. The micrograph shows an enlarged view of the holes running through the length of the glass fiber.

FIG. 3 shows a schematic representation of a method of delivering a coaxial flow of liquid, with one liquid of certain chemical properties in the outer holes encircling another liquid of differing characteristics through the smaller inner holes. One feature of this arrangement would allow a low volatility liquid to encapsulate or coat another liquid of higher volatility and enable the higher volatility liquid to be used in a high vacuum environment such as space.

FIG. 4 shows a schematic representation of a method of delivering a coaxial flow of liquid, with one liquid of certain chemical properties in the outer holes encircling another liquid of differing characteristics through the inner holes. One feature of this arrangement would allow a low volatility liquid to encapsulate or coat another liquid of higher volatility and enable the higher volatility liquid to be used in a high vacuum environment such as space.

FIG. 5 shows a schematic representation of an arrangement of holes inside a holey fiber for the purposes of creating a “ribbon like” series of individual jets. The exact spacing of the micron-sized holes will allow electrospray jets to be produced at the same time with exacting precision.

FIG. 6 shows a schematic representation of a method of delivering a series of small jets, spaced apart by an exact amount in a single row for enabling a plurality of electrospray jets or extrusion sites to be produced at the same time. This plurality of electrospray jets or extrusion sites will allow a precise deposition of fiber strands to be deposited exactly where wanted to facilitate the creation of large mats of individual fibers.

FIG. 7 shows a schematic representation of a method of using a holey fiber with a series of small jets, spaced apart by an exact amount in a single row to create a large mat by depositing the fibers onto a rotating mandrel. The mandrel will rotate while the holey fiber is spraying jets of fibers onto the surface of the mandrel and deposit a continuous stream of equally spaced fibers.

FIG. 8 shows a schematic representation of a method of using a holey fiber with a series of small jets, spaced apart by an exact amount in a single row to create a large mat by depositing the fibers onto a rotating mandrel. This is the second step in a two step process. The first step is outlined in FIG. 7. The fiber will move quickly in a linear direction, while the mandrel remains stationary. After each single pass with the fiber, the mandrel will be indexed by rotating a few degrees to line up the next sweep of the fiber to end up with a grid of electrospun fibers on the mandrel

FIG. 9 shows a mechanical drawing of three views associated with a device that would comprise an appropriate end cap to allow attachment to a holey fiber for the purposes of electrospraying, electrospinning, or extruding. The end cap could be crimped onto the holey fiber, or affixed by glue or epoxy to keep it in place. This end cap would allow for a combination of chemicals to be sent through the holey fiber by electrospray or extrusion.

FIG. 10 shows a schematic representation of an angled view showing more clearly, the details of the interior of the end cap as outline in FIG. 9.

FIG. 11 shows a cut-away drawing of the end cap detailing the connection to a holey fiber. Although two connections are shown, the described invention is not limited to only two chemical solutions. The end-cap could be made in such a way as to enable three or more individual solutions to be introduced into the holey fiber.

FIG. 12 shows a cut-away drawing of the end cap detailing the connection to a holey fiber which will utilize a single solution for either electrospraying (for the purposes of electrospinning) or extrusion.

FIG. 13 shows a drawing of two possible constructions of using multiple holy fibers to enable large volume electrosprays to be realized. A circular arrangement of holey fibers could be used to create large volume electrosprays, and a rectangular arrangement of holey fibers could be used to create large linear sprays for electrospinning or extrusion applications.

### DETAILED DESCRIPTION OF THE INVENTION

When utilizing an electrospray setup for the purposes of electrospraying or electrospinning, one of the main expenses and a great percentage of the system is that of the hydrostatic feed source. Traditionally these are complicated, expensive, and sophisticated syringe pumps, capable of delivering a controlled and regulated amount of liquid, down to nanoliters [10⁻⁹ L]. Dr. John B. Fenn proposed using a passive, self-regulating feed system in the form of a wick. We all have experience watching a burning candle, and noticed how the flame keeps a perfect balance of melted wax and burning flame. As the melted wax is drawn up through the fibrous bundle we refer to as the “wick”, the flammable vapors from the melted wax are burned off at a constant rate. The wick keeps the rate of burn and the rate of fuel supply in a constant balance, and hence the flame remains constant (actually it is more accurate to state—nearly constant, due to variations in the compounds that make up the wax, the imperfect structure of the fibers that make up the wick itself, and variations in surrounding air flow, that all contribute to slight perturbations in the flame to cause a slight flicker now and then). This ability of the wick to draw up liquid against the force of gravity is known a capillary action. Capillary action is the ability of a liquid to move itself through the mechanism of its adhesion and cohesion. There are attractive forces that exist between similar or “like” molecules of a liquid that will cause the liquid to stick together. This affinity for sticking together is known as cohesion, and will cause a drop of water to merge with other drops of water, to create an ever-increasing mass of water. Another important property of capillary action is that of adhesion. As dissimilar or “unlike” molecules interact, there is an attraction that can exist in varying amounts. In the case of water and glass, the water molecules are attracted to the glass molecules, and will be drawn towards the glass. If one has a small hollow glass tube, then the water will spontaneously start to rise up the tube against the force of gravity. As the amount of liquid increases by rising higher and higher up the hollow glass tube, or capillary tube, there will come a point where the weight of the liquid will exactly balance out the attraction between water and glass (adhesion) and the liquid will cease to rise any higher. For a liquid to rise in a capillary tube, the force of adhesion must be greater than that of cohesion. If the force of cohesion is greater than that of adhesion, then the liquid will not rise, but drop lower than the surrounding liquid level, and down into the capillary tube. This is the case if mercury is used; the cohesive forces are greater than that of the adhesion. Many a school kids' science project was performed with a stalk of celery or a flower dipped in colored water to display the effects of capillary action. As the colored liquid slowly rose up through the celery stalk of flower, the color of the water was imparted to it also.

For the most part, the wick fed candle is a marvel of nature, as there are no moving parts (not counting molecules and fluid flow) that can wear out, and it is entirely self-regulating. It would be cumbersome (but also possible) to construct a miniature pump that would both melt the wax and deliver a liquid flow at a regulated rate to keep the flame in balance. The difficulty would come in to play if one were asked to do this without any external power source and make sure it is reliable for a period of several years. Needless to say, nature has provided a very elegant solution to the problem of delivering a small and regulated amount of fuel to keep the system in perfect balance. Dr. John B. Fenn, who immediately saw the potential to electrospray applications, realized this fact. Nature has also provided a similar solution to that of supplying water to small plants and giant trees. Through the use of capillary action, the plant and in like manner the tree was designed with a liquid transport system utilizing capillary action. The tree and plant (actually the tree is a plant, but I use the term plant to distinguish relative size—a plant being small, like a single daisy, and the tree being large like a giant sequoia) both use a the same liquid transport mechanism that utilizes capillary action, but instead of small glass tubes, there is an equivalent vascular structure of tiny tubes running the length of the plants and trees called, Xylem and Phloem. The Xylem and Phloem together form a continuous vascular system that run lengthwise throughout the plant providing both water and structural stability. Multitudes of small holes of varying sizes are formed inside the fibrous bundle of material to establish the capillary action required to transport liquid throughout the organism. It is this continuous network of holes running through the length of the plant that were sought to be copied into making a glass wicking structure for a passive fluid delivery system. Although there exist several techniques for drilling or producing small holes in glass, there are limitations as to the size and depth of those holes. Most places that perform actually drilling through the glass have a size limit of about 4 or 5 thousandths of an inch, and that is only good for about a ⅛ of an inch. A glass wick would require holes on the order of micrometers (μm) or sub-micrometers in diameter and running the entire length of the wick structure, with the length from as small as half an inch, to as long as several feet. If a laser is used to drill tiny holes in the glass structure, then the limitation of a short depth is encountered. To construct an acceptable wick with the desired uniform capillary hole diameter ranging from tens of micrometers in diameter to as small as sub-micrometers through the length of the glass structure, only one item has been found to fit the bill—Holey fibers.

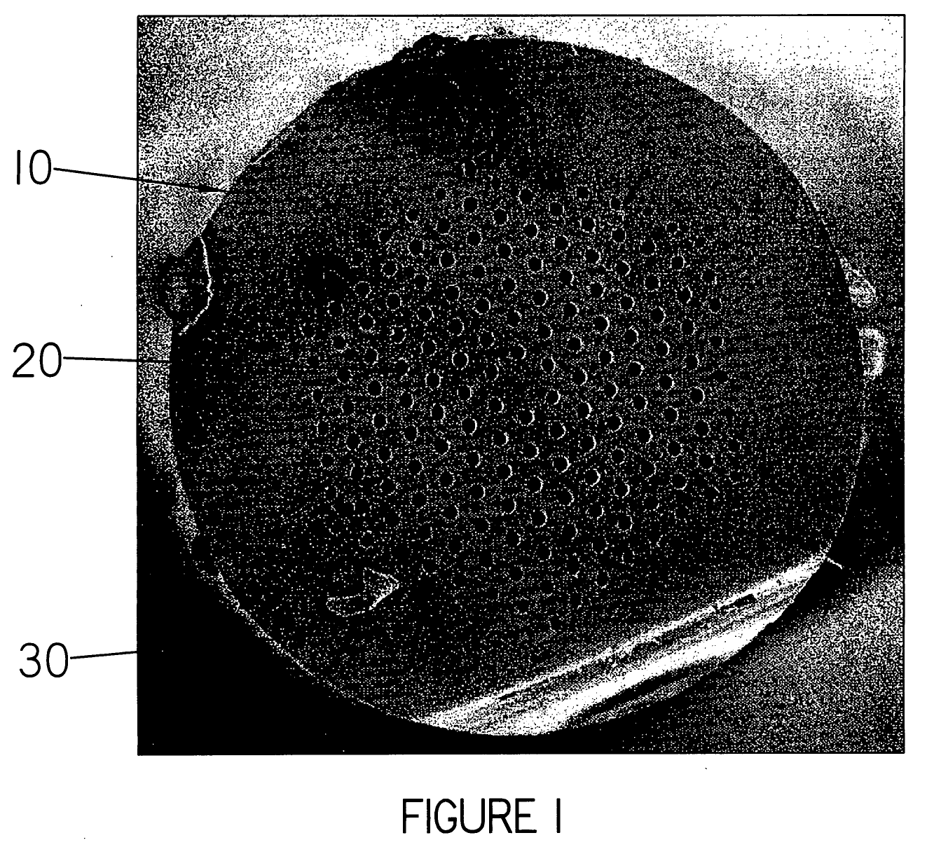

FIG. 1 shows a SEM micrograph of one of the holey fibers. Holey fibers are a relatively new class of optical waveguide that use an array of tiny hollow channels, or holes 20, to guide light in a novel way. A team of scientists at the Optoelectronics Research Center (ORC) at the University of Southampton, UK, have developed a process for producing optical fibers with hole diameters ranging from about ½ μm to as large as tens of micrometers, with an outer fiber diameter 10 of 200 μm and lengths as much as several kilometers. The core material is silica glass 30, and is identical to that used in the core of traditional optical fibers, the difference comes in the fact that there is no cladding surrounding the core. Traditional optical fibers have a core glass material surrounded with a cladding glass material, each with different indexes of refraction that are designed to “trap” or guide light through the fiber using internal reflection. These holey fibers don't have the need for a cladding material to surround the core; the holes running through the core serve to guide the photons of light.

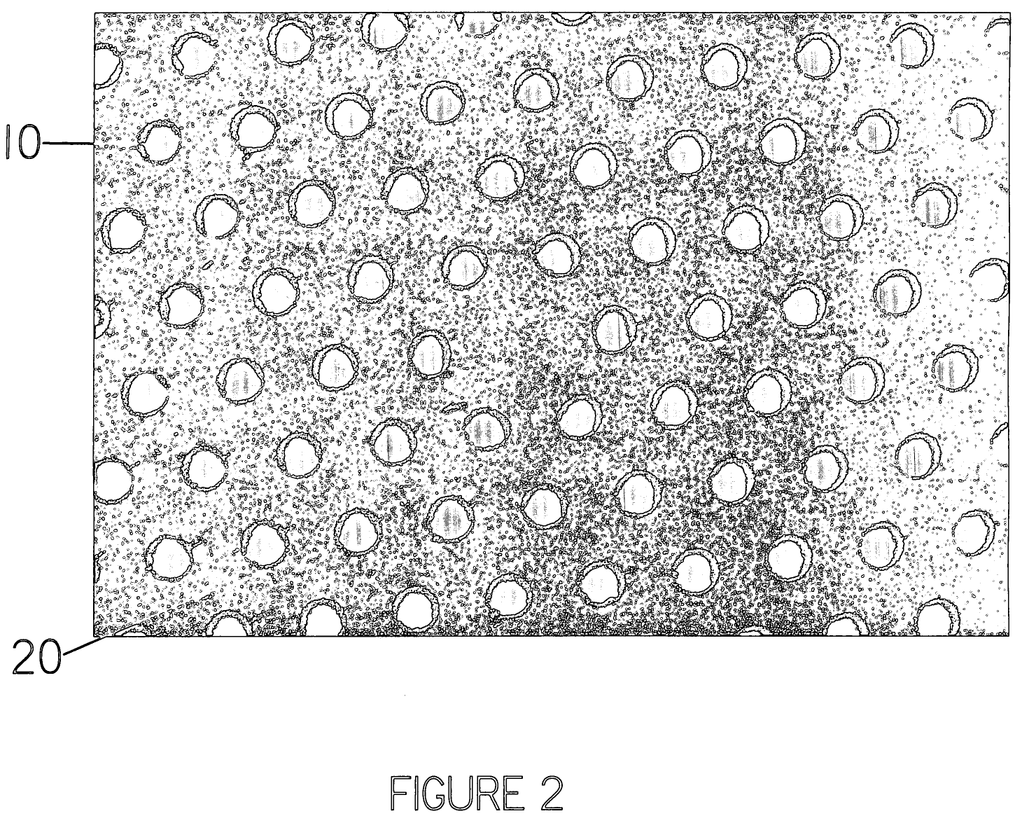

FIG. 2 shows a SEM micrograph of a close up view of the front face of the holey optical fiber. The holes 10 are shown arrayed in a regular, repeating fashion throughout the core glass material 20. Although the picture shows many regularly spaced holes, this need not be the case. Different hole spacing and hole diameters could be utilized in a concentric fashion to accomplish a more efficient delivery system. By using these “Holey fibers” as a wicking structure for electrospray applications, highly efficient needle sources could be produced to form a self-regulating feed system. The Idea of using a wick as a self-regulating capillary feed system that eliminates the necessity for a hydrostatic feed pump was first proposed by Dr. John B. Fenn. Dr. Fenn, who is a pioneer of electrospray ionization mass spectroscopy (ESIMS), was recently awarded the Nobel Prize in chemistry (December 2002) for his contributions to the art. The disclosed invention will use a single small section of “Holey fiber” or a plurality of “Holey fibers” to act as the small, wick filled needle source for electrospray applications. The plurality of holey fibers could facilitate a greater flow rate than could be accomplished by a lone single holey fiber. The Holey fiber wick is capable of delivering a regulated flow rate down to a range of Picoliters [10⁻¹² L] per second. To design a small syringe pump to do the same job would be extremely complex and costly to implement. Using a different Holey optical fiber with different sized diameter holes could vary flow rates. A low flow rate would be realized with a Holey fiber containing holes as small as tenths of a micron, while a higher flow rate would be realized by using a Holey fiber containing holes as large as 20 μm. The size of the holes in the Holey fiber could be balanced with the number of holes contained in the fiber. By using smaller holes, a lower flow rate would be realized, but if more holes are contained inside the fiber, an increase would be noted. Some previously created Holey fibers have hole diameters around 4.7 μm and 168 holes in the fiber. If a higher flow rate were needed, the number of holes could be increased, or the size of the holes could be increased. Different combinations of hole size and number of holes could be used. Care must be taken to include different chemical mixtures and taking into consideration their surface tension and density. One chemical substance could perform very well using capillary action with one holey fiber while not performing well on another holey fiber containing larger or smaller diameter holes.

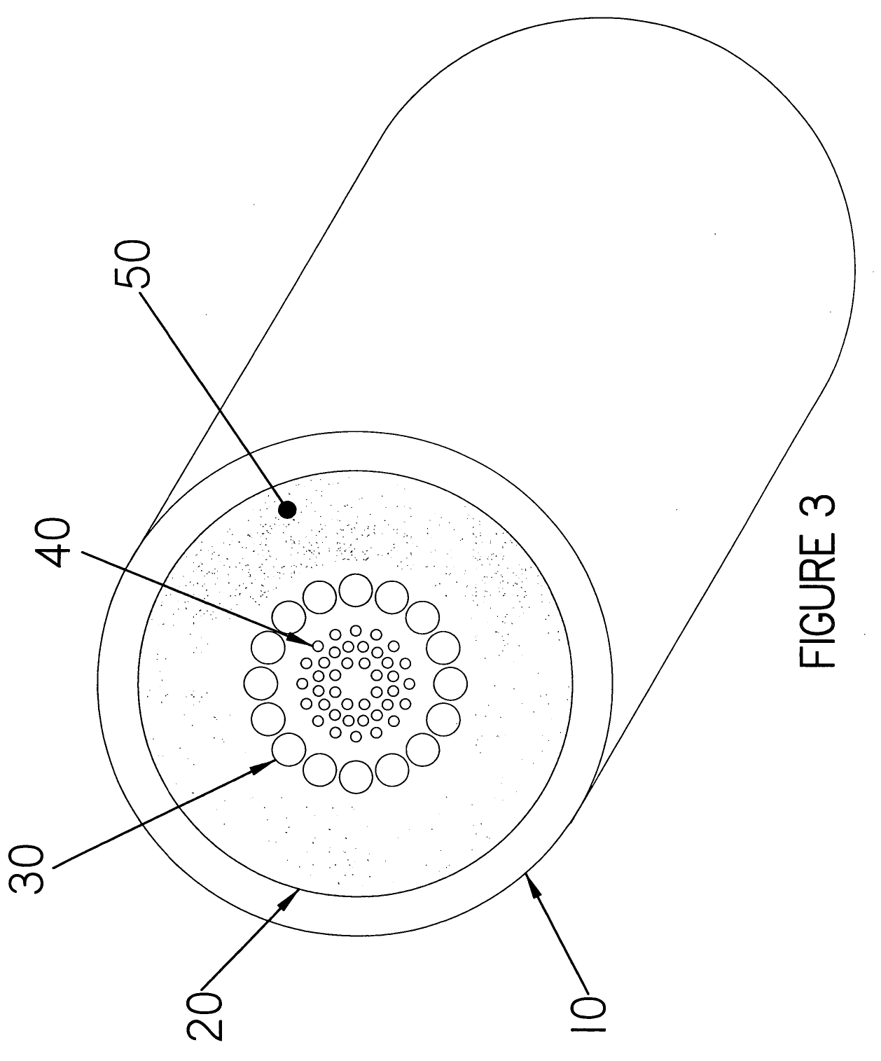

Some man made polymer fibers can be easily made by simply combining two chemicals together; Nylon is one of these polymers. The two main ingredients are Hexamethylenediamine and Sebacoyl Chloride. When the two chemicals are placed together in a beaker and the interface between the two solutions are pulled with a pair of forceps or tweezers, a long continuous strand of Nylon can be produced. Other polymers require external heat to accomplish the “polymerization” process to commence. By utilizing a holey fiber to form a co-axial delivery system, as shown in FIG. 3, small microfibers or even nano-fibers can be produced. A series of concentric holes could be placed in a pattern of inner holes 40 and surrounded by a concentric ring of outer holes 30. The holes will run the length of the fibers glass core material 20. The face of the cleaved fiber core glass could be coated or treated to be made hydrophobic 50. By making the face surface of the fiber hydrophobic, the liquids emerging from the holes 30 and 40, will be confined towards the center of the holey fibers face to increase the probability of mixing the two chemical solutions. The holey fiber can optionally be covered in a protective coating 10 to keep the fiber from being easily cracked or broken. With this type of setup, a co-axial flow of two distinct chemicals could be mixed or merged “on the fly” by using the process of electrospinning or extrusion. New types of polymers or pharmaceuticals could be created that would be difficult to do by any other means. Chemicals that are very costly, volatile, or difficult to work with could be handled easily with a co-axial holey glass fiber. Additionally, chemicals with differing vapor pressures or chemical characteristics could utilize different sized holes, to make the process more efficient.

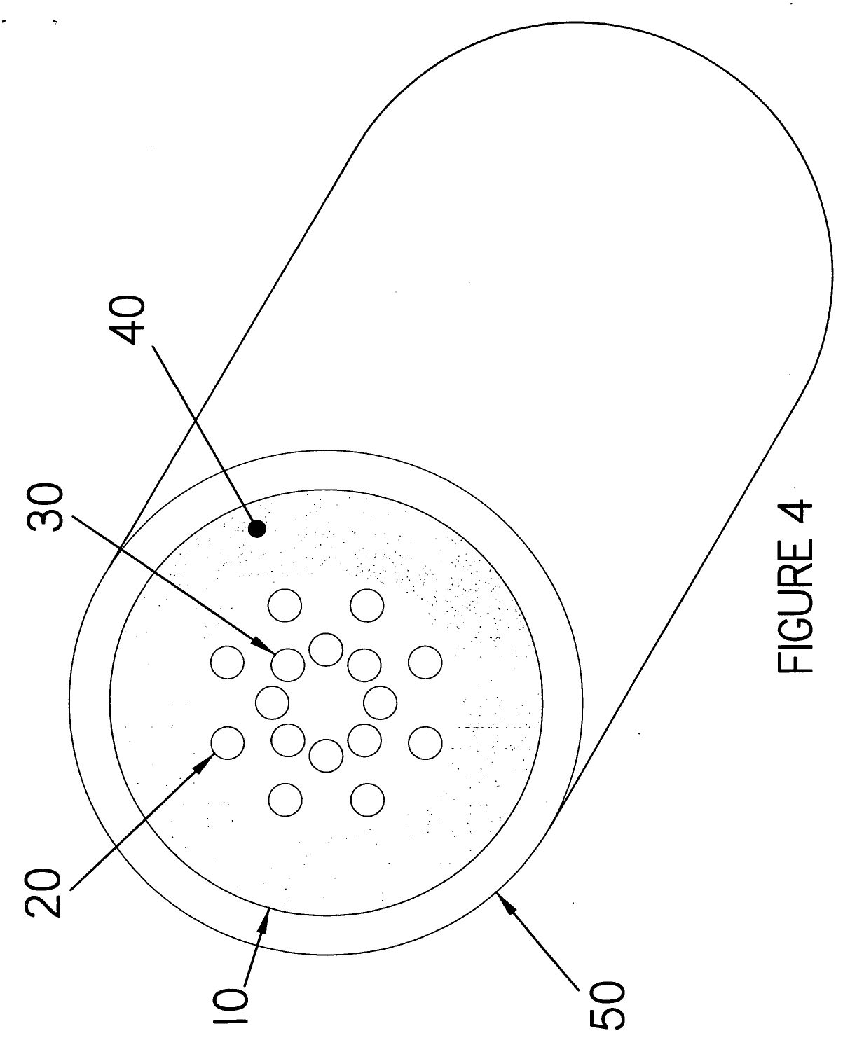

Another co-axial delivery system is shown in FIG. 4. With this arrangement, small microfibers or nano-fibers can be produced. A series of concentric holes could be placed in a pattern of inner holes 30 and surrounded by a concentric ring of outer holes 20. The holes will run the length of the fibers glass core material 10. The face of the cleaved fibers' core glass could be coated or treated to make it hydrophobic 40. By making the face surface of the fiber hydrophobic, the liquid emerging from the holes 20 and 30, will be confined towards the center of the holey fibers face to increase the probability of mixing the two chemical solutions. The holey fiber can optionally be covered in a protective coating 50 to keep the fiber from being easily cracked or broken. With this type of setup, a co-axial flow of two distinct chemicals could be mixed or merged “on the fly” by using the process of electrospinning. New types of polymers or pharmaceuticals could be created that would be difficult to do by any other means. Chemicals that are very costly, volatile, or difficult to work with could be handled easily with a co-axial holey glass fiber.

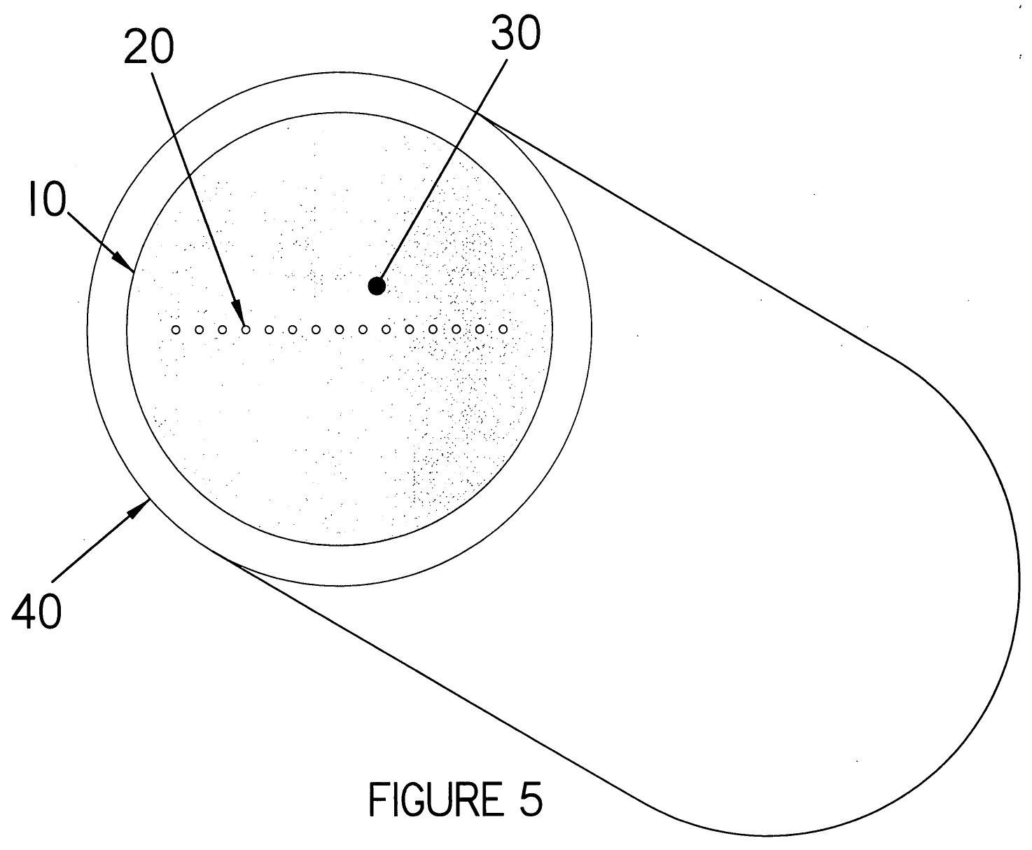

FIG. 5 shows a schematic representation of a holey fiber that has all the holes placed in the same linear plane, or confined to a single row. The holey fiber core glass material 10 has a line of specifically placed small holes 20, that are intended to create a plurality of equally spaced jets. The face of the holey fiber could be treated to make it hydrophobic 30 for the same reasons as outlined previously. This arrangement is intended to enable the electrospinning or extrusion of a single solution. The holey fiber can optionally be covered in a protective coating 40 to keep the fiber from being easily cracked or broken.

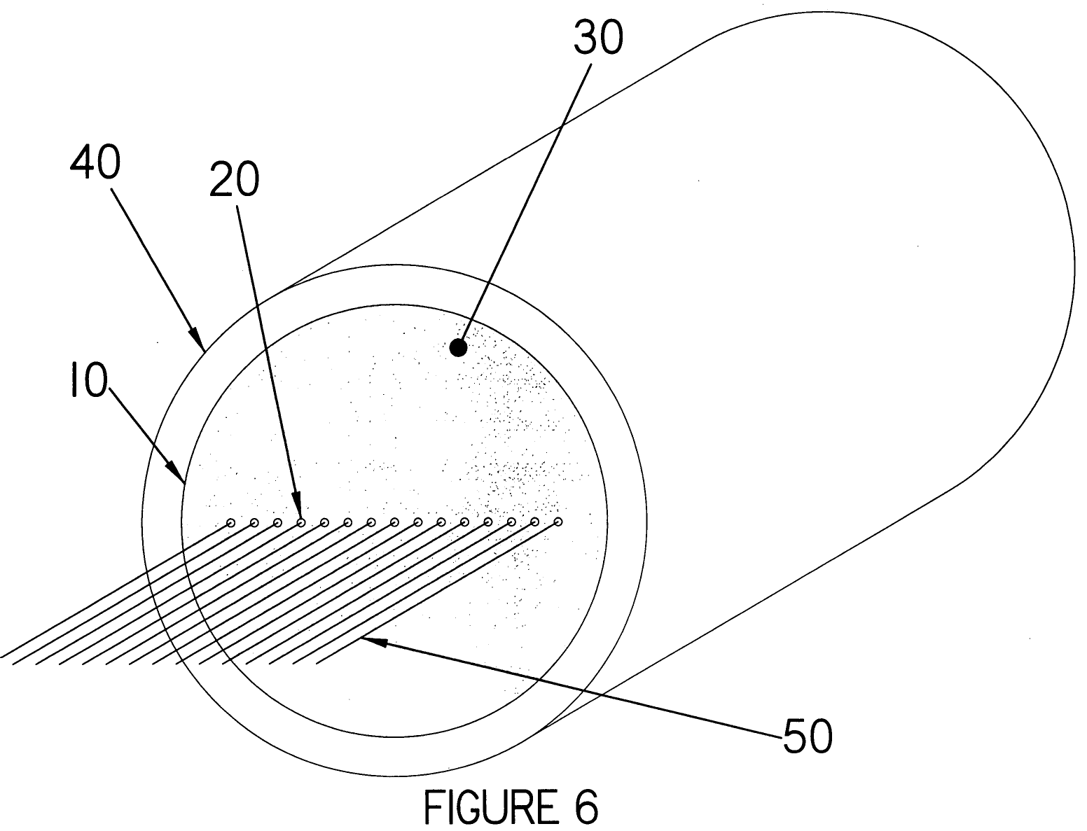

FIG. 6 shows a schematic representation of the same holey fiber as described in FIG. 5, with the only difference being that the electrospray or extrusion jets being shown. FIG. 6 shows the holey fiber core glass material 10 containing a line of specifically placed small holes 20, that are intended to create a plurality of equally spaced jets 50. The face of the holey fiber could be treated to make it hydrophobic 30 for the same reasons as outlined previously. This arrangement is intended to enable the creation of a large mat of material. The holey fiber can optionally be covered in a protective coating 40 to keep the fiber from being easily cracked or broken. As the solution to be electrosprayed or electrospun is drawn up through the holes 20 running the length of the holey fiber, the applied electric field will cause the formation of “so called” Taylor cones to be created. As the Taylor cone is created, a fine stream, or jet of material is created 50. The holes 20 are spaced at a precise distance to help create a large mat for later use. The holey fiber could alternatively be used to create jets of fibers through an extrusion process.

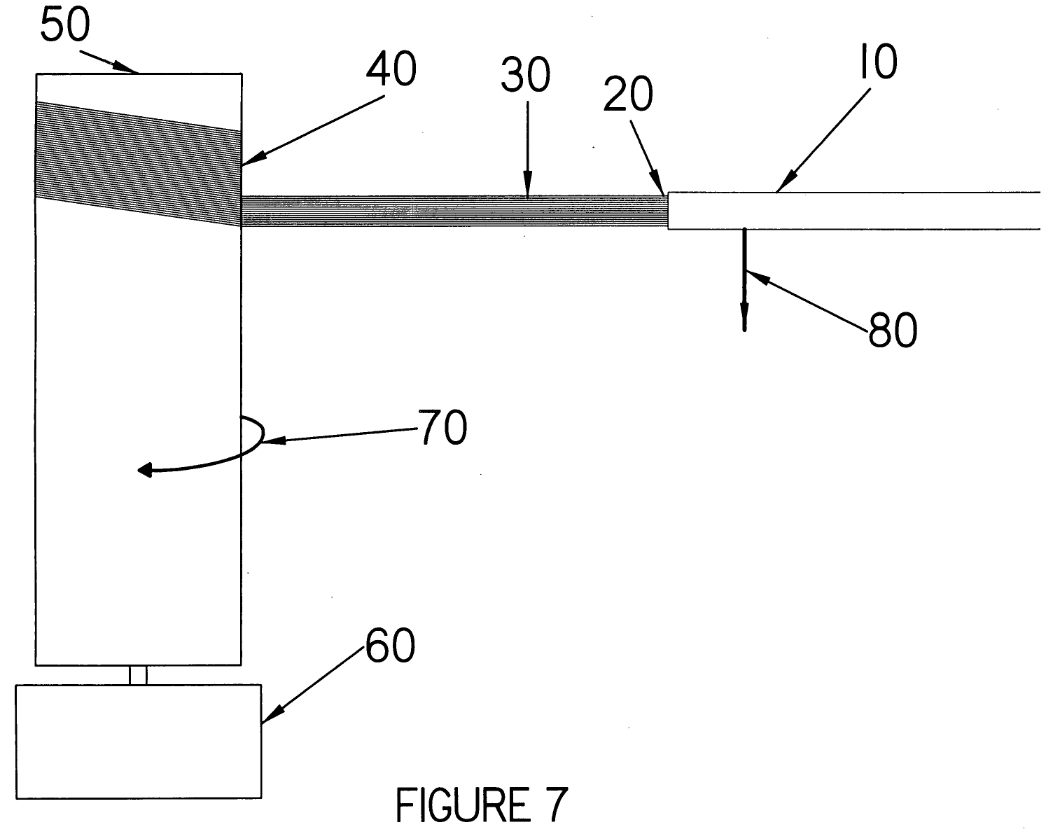

FIG. 7 shows the same holey fiber 10 as discussed in FIGS. 5 and 6 with a high voltage applied to create a stream of material 30 emitting from the holes in the face of the fiber 20. The rotating mandrel 50 is at either ground or a potential opposite that of the solution contained in the holey fiber. As the jet of electrospun material 30 gets attracted to the mandrel, the attached stepper motor 60 will rotate the mandrel 50 as the holey fiber 10 moves in a direction 80 towards the motor side of the rotating mandrel 50. The rate of rotation of the mandrel 70 and the rate of linear motion of the holey fiber 80, will be set so that the resulting deposited electrospun material will form a continuous, non-overlapping single layer covering of the mandrel surface. The result will be an evenly spaced, single layer of uniform fibers.

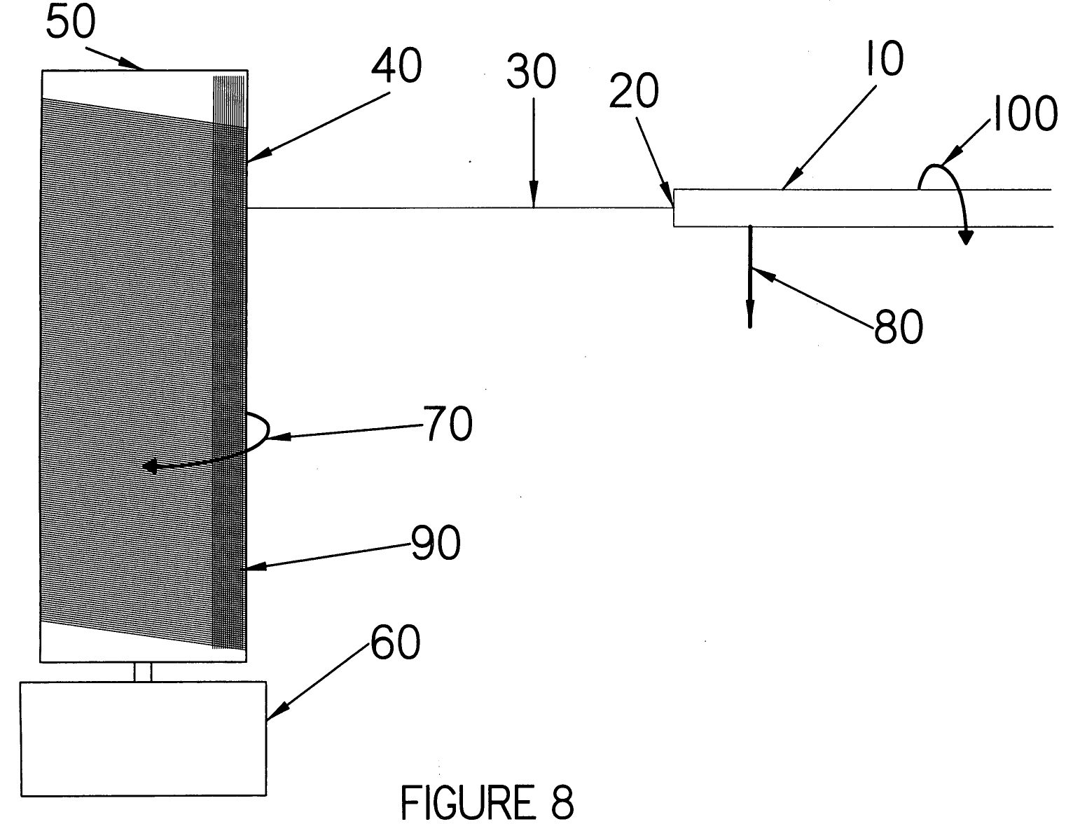

FIG. 8 details the second part of a two-part process started in FIG. 7 for creating large mats or two dimensional, uniform grids of fibers by the process of electrospinning or extrusion. The setup shows the same holey fiber 10 as discussed in FIGS. 6 and 7 with a high voltage applied to create a stream of material 30 emitting from the holes in the face of the fiber 20. (It should be noted that if the material is extruded, then the high voltage is no longer needed). Before electrospraying or extruding, the holey fiber 10 must be rotated 90 degrees 100 so that the series of holes will now be aligned in a vertical fashion, perpendicular to the previous layout. The mandrel 50 is at either ground or a potential opposite that of the solution contained in the holey fiber. As the jet of electrospun material 30 gets attracted to the now stationary mandrel 50, the holey fiber 10 will move in a direction 80 towards the motor 60 side of the mandrel 50. The rate of rotation of the mandrel 70 will no longer be continuous, but will be indexed in small steps. The mandrel 50 will be indexed in discrete steps by the stepper motor 60. The rate of linear motion of the holey fiber 80, will be set so that the resulting deposited electrospun or extruded material will form a continuous, perpendicular single layer covering of the mandrel surface 90. The result will be an evenly spaced, grid of uniform fibers 90. It should be stated that another innovation of Dr. John B. Fenn is to utilize a varying polarity voltage between the target (in this case the mandrel 50) and the high voltage source connected to the solution to be electrosprayed or electrospun, and this innovation should be utilized to maintain a precise deposition of fibers onto the mandrel 50. The varying or alternating voltage will prevent charge buildup on the fibers, and enable more precise control of deposition. The preferred method of varying the high voltage will be to rapidly switch the source from a positive voltage, to that of an opposite polarity. The resulting waveform with respect to time, will be that of a square wave. The frequency of operation would encompass a range from a few Hertz up to several Kilohertz (10³ Hertz). The mandrel 50 would remain at ground potential the whole time.

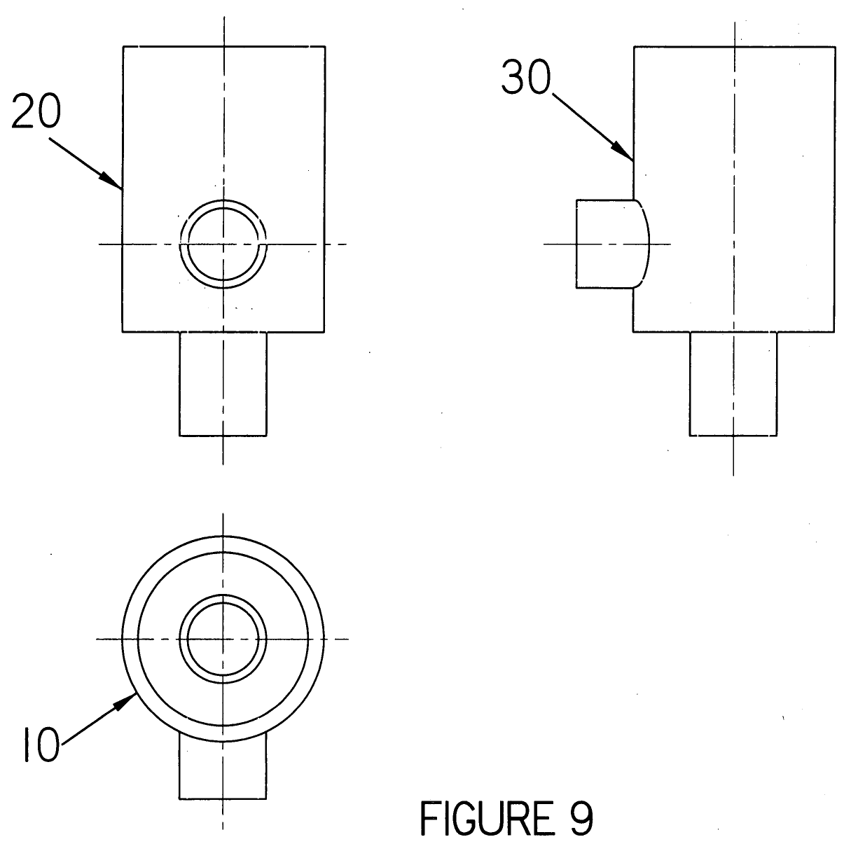

FIG. 9 details a mechanical drawing of an end cap for enabling a mechanical connection to the holey fiber to permit two distinct chemical solutions to be introduced into the holes inside the holey fiber. The mechanical drawing consists of a top view 10, a front view 20, and a side view 30. The holey fiber will be placed inside the large opening shown in the top view 10.

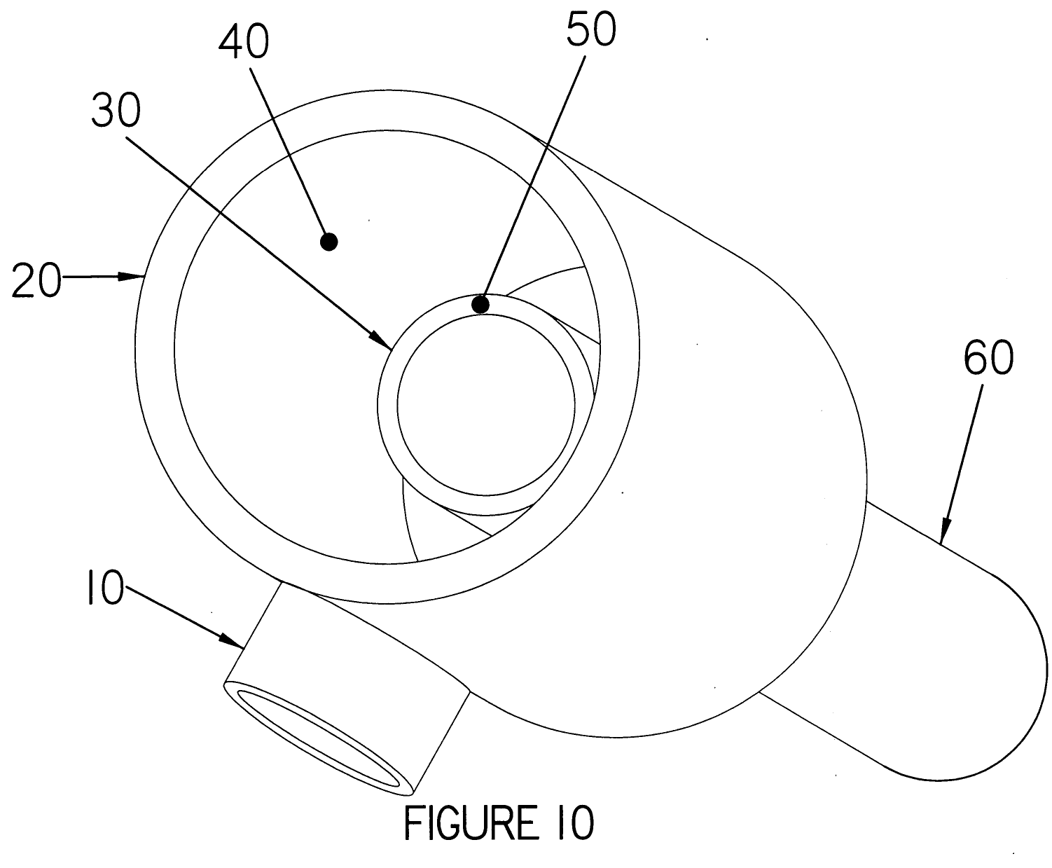

FIG. 10 details a schematic representation of an angled view showing more clearly, the details of the interior of the end cap that was pictured in FIG. 9. The outer fluid inlet tube 10 will enable one of the pair of chemical substances to be introduced into the holey fiber. The main housing 20 will contain the cleaved end of the holey fiber. The type of holey fiber that will be used with this type of end cap will be that as outlined in FIG. 3 or 4. The holey fiber will be placed into the main housing 20 until the cleaved end of the holey fiber makes contact with the inner fluid inlet tube 30. The face of the end of the inner fluid delivery tube 50 could be coated with a small amount of adhesive or epoxy to form a permanent seal with the holey fiber. The inside wall 40 of the main housing 20 could also be coated with a small amount of adhesive or epoxy to keep the holey fiber firmly secured into the end cap. When running two distinct chemical solutions through the holey fiber, a small hose or tube must be connected to the external inner fluid delivery port 60 to supply chemical “A”, and a second small hose or tube must be connected to the outer fluid delivery port 10 to supply chemical “B”. The design of the end cap will prevent the two chemicals from mixing together until they exit the holes at the face end of the holey fiber. As an alternative to using an adhesive or epoxy, the main housing can be mechanically crimped to the fiber to hold the holey fiber in place.

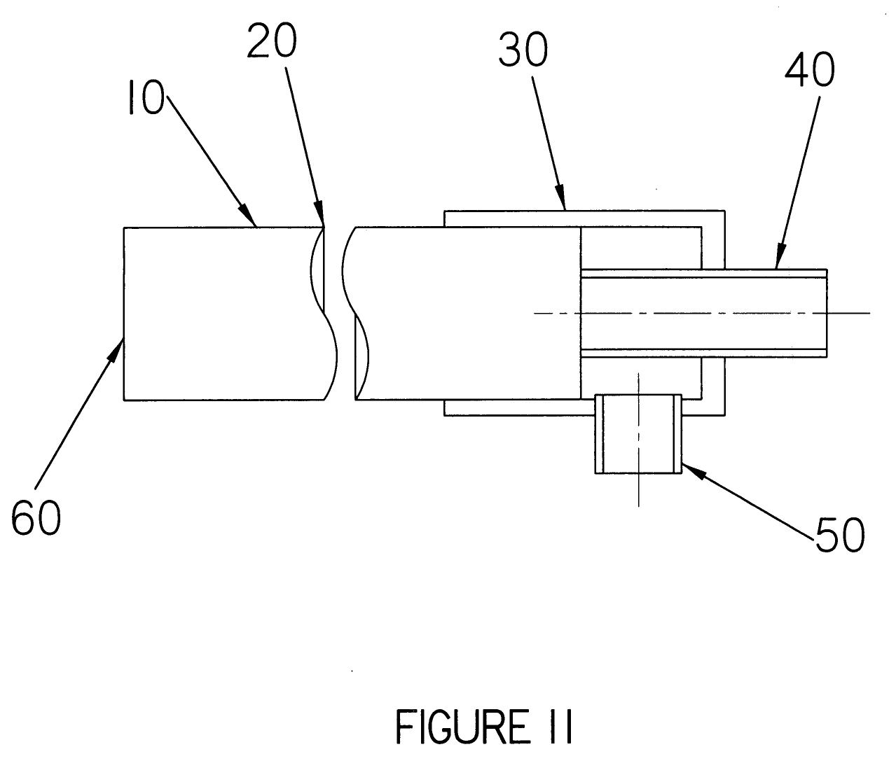

FIG. 11 shows a side, cut-away view of the end cap described in FIG. 10 with the introduction of a holey fiber. The holey fiber 10 is held firmly in place by the walls of the main housing 30 either due to an adhesive or epoxy coating on the inside wall, or by mechanical crimping. The entire length of the holey fiber 10 is not shown, because it could vary in length. A break 20 is shown to indicate that the length is not indicated, although the fiber 10 is not physically broken, the break 20 is used for descriptive means. The holey fiber 10 is shown firmly seated to the inner inlet fluid delivery port 40. The face end of the inner fluid delivery port 40 could be coated with a small amount of adhesive or epoxy to make sure that the two distinct chemicals to be introduced into the holey fiber do not mix until-they-emerge from the holes at the face end of the holey fiber 60. The outer fluid delivery port 50 will supply the second of the two chemical substances to be introduced into the holey fiber.

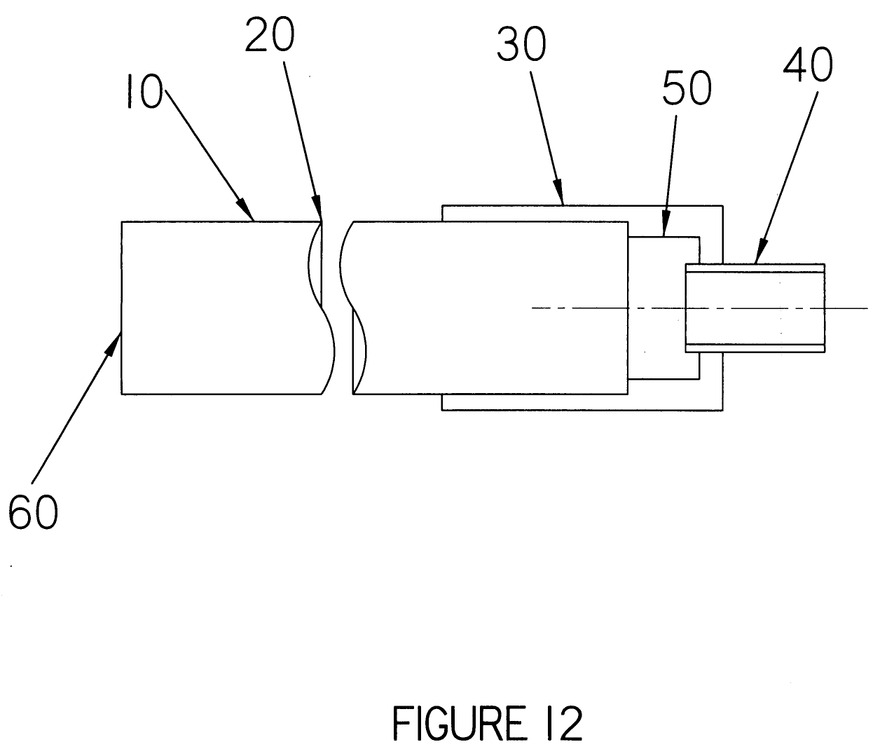

FIG. 12 shows a side, cut-away view of an end cap that could be used primarily for an extrusion process of a single chemical solution, including the holey fiber. The holey fiber 10 is held firmly in place by the walls of the main housing 30 either due to an adhesive or epoxy coating on the inside wall, or by mechanical crimping. The entire length of the holey fiber 10 is not shown, because it could vary in length. A break 20 is shown to indicate that the length is not indicated, although the fiber 10 is not physically broken, the break 20 is used for descriptive means. The holey fiber 10 is shown firmly seated to the inner fiber stop 50, this prevents the fiber from pressing against the fluid delivery port 40. The face end of the fiber stop 50 and the inner wall of the main housing 30 could be coated with a small amount of adhesive or epoxy to make sure that the holey fiber is held firmly in place. The fluid delivery port 40 will supply the chemical substance to be introduced into the holey fiber 10.

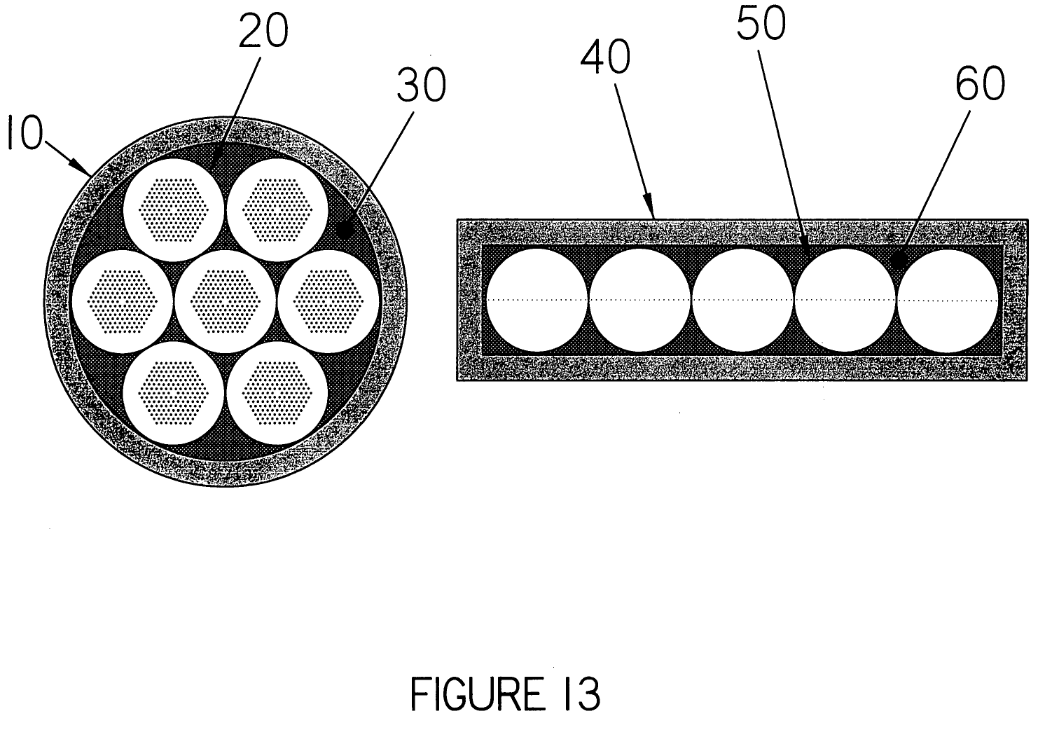

FIG. 13 details two possible arrangements for using a plurality of holey fibers for the purposes of large volume electrospray, extrusion and electrospinning applications. The first circular arrangement of holey fibers shows a bundle of single holey fibers 20 enclosed inside a rigid housing 10 and firmly encapsulated in place by the use of epoxy or an adhesive 30. This will enable the generation of large volume electrosprays, extrusions, or electrospinning applications. The second arrangement of using a plurality of holey fibers shows a rectangular rigid housing 40 enclosing several holey fibers 50 that have been firmly encapsulated in epoxy 60 or some other type of adhesive. The rectangular arrangement of holey fibers would be made with holey fibers 50 that contain a single row of sub-micron holes, all arranged in the same direction. The advantage of this setup is that a large mat of precisely spaced fibers (electrospun or extruded) could be built up on a rotating mandrel as in FIGS. 7 and 8. The plurality of holey fibers would enable fast creation of polymer mats for the purposes of patches. In medical applications, a large mat of collagen could be extruded or electrospun to manufacture sheets of precisely spaced strands that would mimic that found in the human body, such as the cornea of the eye.

An added benefit of using a holey fiber is that it is made from glass, which is chemically inert. With the exception of certain Fluorine compounds, virtually any chemical could be used with a holy fiber. Another advantage to using a glass holey fiber is that the fiber itself could be heated to relatively high temperatures to catalyze different chemical solutions. There are several methods that can be used to heat the solution to be polymerized (if heat is needed), some of which are microwaves, infra-red radiant heating, contact heating using an electric heating element, gas flame heating (assuming the liquids are not flammable), just to name a few. When it comes to Spider silk, the process could be mimicked. There are several glands located at the spider's abdomen, which produce the silken thread. Every gland produces a thread for a special purpose of which there are only seven different glands known. Each spider possesses some of these glands and not all seven together. The glands known as Glandula Ampulleceae major and minor are used for the silk of the walking thread. Glandula Pyriformes is used for the production of the attaching threads. Glandula Aciniformes produces threads for the encapsulation of prey. Glandula Tubiliformes produces Thread for cocoons. Glandula Coronatae is used for the production of the adhesive threads. Normally a spider has three pairs of spinnerets; there are however, spiders with a single pair or as many as four pairs of spinners. Every spinner has it own unique function. There are small tubes in the spinners, which are connected to the glands. The number of tubes varies between 2 and 50.000. There are instances where it is difficult, dangerous or even impossible to combine certain chemicals together. If a small chemical weapon were needed that would deliver small controlled amounts of a “nerve agent”, then using a plurality of holey fibers would be feasible. Each individual holey fiber would have a pair of concentric ring of holes for the delivery of each chemical part. A single holey fiber could be used, or a multitude of individual holey fibers could be grouped together to act as a single large holey fiber. When dealing with microfibers or even smaller nano-fibers, a holey fiber could be used that would be comprised of a single row of equally spaced micron sized holes to facilitate the production of large-mats of material to be produced.

In the area of space propulsion, there exists a low thrust mechanism known as colloidal propulsion. The amount of thrust is typically in the micronewton range [10⁻⁶ Newton], and is used as more of attitude adjustment or in the case of a constellation of satellites, to balance out the effect of Solar wind. Colloidal propulsion uses electrospray to create a fine jet of droplets that are accelerated away from an electrospray needle at a high rate (up to several times the speed of sound). The advantage of using a colloidal thruster for propulsion is that it is one of the few controllable methods of producing tiny amounts of thrust. Chemical rockets are normally used for high load applications where a great amount of mass has to be accelerated (Space Shuttle, Saturn V Rocket, etc.) To effect a small amount of controlled thrust, a metering mechanism must be employed to deliver a controlled, and precise amount of propellant. The use of valves and pumps increases not only the complexity of the device, but also the cost. The reliability of the system would be greatly reduced by the complexity of sophisticated pumps and valves. A method was proposed by Dr. John B. Fenn and Joseph J. Bango Jr. to eliminate the complexity and increase the reliability of operation—The use of a wick based fluid feed system. One major disadvantage of this system is the problem creating a suitable wick. The needle must be small to limit the exposure of the propellant to space, and this presents a problem for placing a fibrous wick material inside a small bore needle (around 50 μm). FIG. 4 describes a preferred embodiment of a possible passive coaxial fluid feed system. The described invention solves this problem by both having holes that are on the order of 5 μm and are completely covered, thereby limiting the exposure of the colloidal fluid to the vacuum of space. A fluid with a low or near zero vapor pressure will not evaporate in the vacuum of space, but will have only a nominal amount of thrust. A colloidal fluid with a slightly higher vapor pressure will have a greater amount of thrust, but will evaporate prematurely if exposed to the vacuum of space. If the exposure to space were limited, as in the case of a holey fiber, then the amount of evaporation could be controlled and kept to a low value. This would make a higher vapor pressure colloidal fluid a viable candidate for space applications. The holey fiber acts as a sheathed or covered wick, and thus limits the exposure of the liquid to a high vacuum environment, such as space. In the area of space propulsion it would be preferable to have a plurality of Taylor cones to increase the overall thrust. If the surface of the holey optical fiber were treated to make it hydrophobic 50, that is to make it repel liquid, then each individual capillary, would behave as an individual electrospray needle source. The benefit would be that each capillary would have a minimum amount of exposure to a high vacuum environment. One such way to treat the holey optical fiber would be to use a chemical such as Hexamethyldisilazane. If the end to be used as the electrospray source is placed in a small quantity of solution while having a tiny amount of air passed through the holey fiber. Another way to make the end of the fiber hydrophobic is to place a small amount of heated wax (in liquid form) on the end, and allow it to cool. When cooled, the blob of wax could be removed, and the glass surface would now be hydrophobic. Since the wax is so viscous, the need to blow air through the holey fiber to prevent the holes from pulling in liquid through capillary action, may not be an issue. The larger diameter holes 30 would be used to supply a low vapor pressure oil or viscous liquid to act as a protective coating that will be used to coat a liquid with a higher vapor pressure to slow its rate of evaporation in a harsh environment, such as the vacuum of space. The smaller diameter holes 40 would be used to supply a high vapor pressure liquid that is intended to be covered with the low vapor pressure oil or liquid so its rate of evaporation in a harsh environment, such as the vacuum of space, will also be limited. The smaller hole size 40 will limit the exposure of the high vapor pressure liquid to the vacuum of space. An outer protective coating 10 would be used to cover the glass core to prevent scratching or damage. The material that comprises the holey fiber 20 would be silica glass. The glass fiber core face 50 treated to make it hydrophobic, and thereby preventing the liquid solution from reaching the outer edge of the glass holey fiber. The intent is to confine the two liquids to the center of the glass holey fiber to permit mixing, or coating of the higher vapor pressure liquid. The higher vapor pressure liquid will give a higher thrust for colloidal propulsion applications in space, but will evaporate quickly, due to its higher vapor pressure. In the area of aerosol generation such as dispensing scented oils or perfumes, the holey fiber fluid feed system could provide a useful and cost effective solution. Because the holey fiber fluid feed system uses no moving parts, an economical aerosol generator could be fashioned that would enable a highly efficient, reliable, small and compact product. With a low rate of regulated fluid delivery obtainable from a holey fiber fluid feed system, a small quantity of scented oil or perfume could last for an extended period of time.

### REFERENCE NUMERALS

FIG. 1:

10 Outer edge of glass optical fiber (Holey fiber) detailing the circular shape (Note: An outer coating usually placed on the glass fiber to protect it (Buffer) has been stripped off to reveal the naked glass core. The diameter of the glass fiber is approximately 225 μm.

20 One of the 168 holes that run through the length of the fiber. The number of holes can be just a single hole if desired. The hole diameters in this SEM image are approximately 4.7 μm. The Holey optical fibers can be made to be any size from about ½ μm to as large as 20 μm, possibly bigger.

30 Cleaved face of glass optical fiber (Holey fiber). The face of the optical fiber is perpendicular to the length of the fiber. The SEM image indicates a geometric arrangement of 168 holes, but for the described invention, a minimum of only one hole will work.

FIG. 2:

10 Close up view of one of the 168 holes that run through the length of the fiber. The SEM image shows the uniformity of the size of the holes.

20 Close up view of the cleaved face of glass optical fiber (Holey fiber). The face of the optical fiber is perpendicular to the length of the fiber.

FIG. 3:

10 Outer protective coating used to cover the glass core to prevent scratching or damage.

20 Holey fiber glass core material.

30 Uniform diameter holes that are spaced at regular intervals. These will be used to supply a solution to be electrosprayed or extruded.

40 Smaller, uniform diameter holes that are spaced at regular intervals. These will be used to supply a solution to be electrosprayed or extruded.

50 Detail of the glass fiber core face treated to make it hydrophobic, and thereby preventing the liquid solution from reaching the outer edge of the glass holey fiber. The intent is to confine the liquid to the center of the glass holey fiber.

FIG. 4:

10 Holey fiber glass core material.

20 Uniform diameter holes that are spaced at regular intervals. These will be used to supply a solution to be electrosprayed or extruded. The concentric circular arrangement of the holes will enable two distinct solutions to be electrosprayed or extruded.

30 Uniform diameter holes that are spaced at regular intervals. These inner holes will be used to supply a second solution to be electrosprayed or extruded. The concentric circular arrangement of the holes will enable two distinct solutions to be electrosprayed or extruded.

40 Detail of the glass fiber core face treated to make it hydrophobic, and thereby preventing the liquid solution from reaching the outer edge of the glass holey fiber. The intent is to confine the liquid to the center of the glass holey fiber.

50 Outer protective coating used to cover the glass core to prevent scratching or damage.

FIG. 5:

10 Holey fiber glass core material.

20 Uniform diameter holes that will be arranged in a single row to supply the chemical to be electrosprayed or extruded.

30 Detail of the glass fiber core face treated to make it hydrophobic, and thereby preventing the liquid solution from reaching the outer edge of the glass holey fiber. The intent is to confine the liquid to the center of the glass holey fiber.

40 Outer protective coating used to cover the glass core to prevent scratching or damage.

FIG. 6:

10 Holey fiber glass core material.

20 Uniform diameter holes that will be arranged in a single row to supply the chemical to be electrosprayed or extruded.

30 Detail of the glass fiber core face treated to make it hydrophobic, and thereby preventing the liquid solution from reaching the outer edge of the glass holey fiber. The intent is to confine the liquid to the center of the glass holey fiber.

40 Outer protective coating used to cover the glass core to prevent scratching or damage.

50 Jets created by electrospray, extrusion, or electrospinning that will enable a precise arrangement of a plurality of fibers to be created.

FIG. 7

10 Holey fiber containing a series of single holes all arranged in a single row.

20 Cleaved face end of holey fiber.

30 Stream of material emitting from the holes in the face end of the holey fiber.

40 Evenly spaced, single layer of uniformly spaced electrospun or extruded fibers.

50 Mandrel that will be rotated to enable capture of fibers.

60 Stepper motor that will be used to rotate the mandrel as the holey fiber deposits fibers.

70 The direction of rotation of the mandrel.

80 The direction of linear motion of the holey fiber, enabling the resulting deposited electrospun material to form a continuous, non-overlapping single layer covering of the mandrel surface.

FIG. 8

10 Holey fiber containing a series of single holes all arranged in a single row.

20 Cleaved face end of holey fiber.

30 Stream of material emitting from the holes in the face end of the holey fiber.

40 Evenly spaced, single layer of uniformly spaced electrospun or extruded fibers.

50 Mandrel that will be rotated to enable capture of fibers.

60 Stepper motor that will be used to rotate the mandrel as the holey fiber deposits fibers.

70 The direction of rotation of the mandrel.

80 The direction of linear motion of the holey fiber, enabling the resulting deposited electrospun material to form a continuous, overlapping second layer to cover the mandrel surface to form a grid.

90 The deposited electrospun material from the holey fiber, forming a continuous, overlapping second layer to cover the mandrel surface to form a grid.

100 The direction of rotation of the holey fiber, to enable the second coating of fibers to coat the mandrel with a grid of regularly spaced fibers.

FIG. 9

10 The mechanical drawing of an end cap outlining the top view

20 The mechanical drawing of an end cap outlining the front view

30 The mechanical drawing of an end cap outlining the right side view

FIG. 10

10 The outer fluid inlet tube that will enable one of the pair of chemical substances to be introduced into the holey fiber.

20 The main housing that will contain the cleaved end of the holey fiber.

30 The inner fluid inlet tube that will be used to supply one of the two distinct solutions that will be electrosprayed, extruded, or electrospun through the holey fiber.

40 The inner wall of the main housing that will contain the cleaved end of the holey fiber.

50 The face end of the inner fluid inlet tube that will make contact with the cleaved end of the holey fiber.

60 The external portion of the inner fluid inlet tube that will enable a connection to an external fluid reservoir.

FIG. 11

10 The holey fiber that will be permanently affixed to the end cap.

20 The indication that there is a break in the holey fiber drawing, indicating that the amount of holey fiber shown could be more. The indicated break is not a mechanical break in the fiber.

30 The main housing that will contain the cleaved end of the holey fiber.

40 The inner fluid inlet tube that will be used to supply one of the two distinct solutions that will be electrosprayed, extruded, or electrospun through the holey fiber.

50 The outer fluid inlet tube that will be used to supply one of the two distinct solutions that will be electrosprayed, extruded, or electrospun through the holey fiber.

60 The cleaved, end face of the holey fiber.

FIG. 12

10 The holey fiber that will be permanently affixed to the end cap.

20 The indication that there is a break in the holey fiber drawing, indicating that the amount of holey fiber shown could be more. The indicated break is not a mechanical break in the fiber.

30 The main housing that will contain the cleaved end of the holey fiber.

40 The fluid inlet tube that will be used to supply the solution that will be electrosprayed, extruded, or electrospun through the holey fiber.

50 The inner fiber stop that will prevent the holey fiber from making contact with the fluid inlet port.

60 The cleaved, end face of the holey fiber.

FIG. 13

10 The rigid circular outer shell that will confine the individual fibers.

20 The individual holey fibers that are enclosed within the rigid shell

30 Epoxy or adhesive that will permanently affix the single holey fibers into the rigid, outer circular shell.

40 The rigid rectangular outer shell that will confine the individual fibers.

50 The individual holey fibers that are enclosed within the rigid shell

60 Epoxy or adhesive that will permanently affix the single holey fibers into the rigid, outer angular shell.

1. a method of utilizing glass optical fibers containing small diameter holes running through the length of the glass fiber to provide for a passive and self regulated liquid feed system

2. a method as in claim 1 where the diameter of the holes are all of uniform size diameters

3. a method as in claim 1 where the diameter of the holes are of varying size diameters
